(19) United States
(12) Patent Application Publication
(10) Pub. No.: US 2024/0044183 A1
(43) Pub. Date: Feb. 8, 2024

(54) MOTOR VEHICLE LATCH

(71) Applicant: Kiekert AG, Heiligenhaus (DE)

(72) Inventor: Uwe REDDMANN, Essen (DE)

(73) Assignee: Kiekert AG, Heiligenhaus (DE)

(21) Appl. No.: 18/256,347

(22) PCT Filed: Dec. 9, 2021
(86) PCT No.: PCT/DE2021/100986

§ 371 Date: Jun. 7, 2023

(30) Foreign Application Priority Data
Dec. 17, 2020 (DE) 10 2020 133 915.1

(51) Int. Cl. E05B 81/14; E05B 81/20; E05B 81/24; E05B 81/46

(52) U.S. Cl. CPC E05B 81/14; E05B 81/20; E05B 81/25; E05B 81/46

(57) ABSTRACT

A method for closing and opening a motor vehicle door and a motor vehicle latch having a locking mechanism with a catch and at least one pawl, wherein a rotary movement of the catch can be locked in at least one latching position by means of the pawl, a drive device, with which the pawl can be transferred from a latching position into a release position for the catch, and a closing device, by means of which the pawl can be transferred from a latching position into a release position for the catch, and a closing device, it being possible by means of the closing device to transfer the latch from a pre-ratchet position into a main ratchet position, and it being possible by means of the drive device to control a coupling element in such a way that the vehicle part can be set up by means of the closing device.

The invention relates to a motor vehicle lock having a catch with a rotary latch and at least one locking pawl, it being possible to lock a rotary movement of the rotary latch in at least one latching position by means of the locking pawl, a drive device by means of which the locking pawl can be transferred from a locking position into a release position for the rotary latch, and an installation device, it being possible to transfer a vehicle part accommodating the motor vehicle lock from a closed position into an open position by means of the installation device.

In order to increase the comfort in a motor vehicle and to make it as easy as possible to operate a motor vehicle, more and more comfort functions are being integrated into the motor vehicle. For example, it is known that vehicle doors, flaps or hoods are closed by means of a closing device. On the one hand, this can be due to the fact that easy closing of the door is to be made possible and, on the other hand, an outer door handle can be dispensed with, for example, in order to achieve a corresponding design on the motor vehicle. Such closing devices are often used, particularly in fully automatic tailgates. These flaps can then be operated, for instance, without manual operation of the flap itself, merely by means of a radio remote control.

Such locking systems, which are equipped with a closing device, are basically used for all possible doors on a motor vehicle. This means that not only side doors, but also trunk doors, tailgates or engine hoods can be acted upon and are included in the scope of the invention. With the aid of the closing device implemented in this way, the door or vehicle door concerned can be moved from the pre-latching position already mentioned to a main latching position against the resistance of a seal.

The design of a drawing device is the subject matter of DE 198 28 040 B4. A power-assisted closing device for doors, flaps, hoods or roofs of motor vehicles and in particular passenger cars is disclosed, in which a pivotable stop element is arranged on a rotary latch. In addition, the pawl interacting with the rotary latch also has a pivotable stop element. The two stop elements interact with a control disk during the opening or closing operation. The control disc is part of an actuator, with the help of which both an opening and a closing process can be effected.

In DE 20 2008 015 089 U1, a transmission lever mounted on the same axis as an axis of a catch of the locking mechanism is provided. In addition, a drive pawl is mounted on a transmission element. The drive pawl is in turn connected to the drive by means of a Bowden cable or another means of connection.

In addition to the aid of a pull drive for locking systems in motor vehicles, raising devices have become known. The preferred purpose of the raising devices is to move the movable component on the vehicle into an open position so that the operator is able to grasp the movable component and open it completely. The raising devices interact with electrically actuated locking systems so that the movable component can be positioned after the locking mechanism has been electrically unlocked. When the locking mechanism is open, for example, a motor vehicle door can be opened without the manual operation of an outside operating handle.

DE 10 2011 015 669 A1 is a known exhibitor for motor vehicle doors or flaps, with which a door, flap or hood can be transferred from a closed position to an open position. For example, if the raising device refers to a vehicle side door, the door can be opened by means of an electrical impulse. For this, the locking mechanism of the door latch must first be unlocked—preferably electrically—so that the door can be opened. For example, if the door seal pressure is not sufficient to move the door from the closed position to an open position, the door can be moved to an open position by means of the raising device. An open position is defined in such a way that the operator of the motor vehicle is able to grasp the door in such a way that he can open the door completely. An electric drive unit is used as the positioning apparatus, which acts mechanically on the motor vehicle door in the form of a pivoting movement of the levers via a drive pawl and an inner and outer lever.

A raising device integrated directly in a motor vehicle door latch is known from DE 200 16 292 U1. The latch, which consists of a pawl and a catch, has a pawl drive that can be used to disengage the pawl from the catch. After an electrical actuation, the pawl drive moves the catch out of the engagement region of the catch and therefore releases the latch holder, meaning the flap, hood or door can be opened. The pawl drive now moves on and, via a connecting lever between the pawl and the catch, pulls the catch into a position in which the lock holder is not only released, but the catch is supported on the lock holder and lifts or moves the motor vehicle part, such as the hood, flap or door, into an open position. This creates a gap between the motor vehicle part and the motor vehicle body, with the gap increasing ease of use. The operator is able to grasp the motor vehicle part through the gap and open it completely.

A motor vehicle latch has become known from DE 10 2015 003 918 A1, having a locking mechanism with a catch and at least one pawl, it being possible to lock a rotary movement of the catch by means of the pawl, a drive device by means of which the pawl can be transferred from a locking position into the release position for the locking mechanism, and a raising device, it being possible to move a vehicle part accommodating the motor vehicle latch out of a closed position into an open position by means of the raising device. In one embodiment, the drive device forms a drive for the raising device. The drive device for electrically opening the motor vehicle latch is preferably an electric motor, which acts on an actuator, for example with a gear, so that the pawl can be released from the catch. If the electric motor in the motor vehicle latch is used as the drive unit for the raising device, there is no need for a further drive for the raising device.

The frequently used prior art closing devices as well as the raising devices have basically proven their worth. One problem that automotive manufacturers, as well as suppliers, are continuously dealing with is that of reducing the weight of motor vehicles and the installation space of components to a minimum. The weight of the individual components can minimize the weight of the vehicle and thus reduce the consumption of the motor vehicle. The increasing number of comfort functions in turn takes up installation space, which is further restricted by the comfort functions.

It is the task of the invention to provide an improved motor vehicle with the described comfort functions, such as a closing aid and a raising device. In addition, it is the task of the invention to provide the comfort functions in a minimum installation space and with the lowest possible number of components. Finally, the object of the invention is that of providing a structurally simple and inexpensive solution.

The object is achieved by the features of independent claim 1. Advantageous embodiments of the invention are specified in the dependent claims. It should be noted that the embodiments described below are not restrictive; rather, any variation of the features described in the description and the dependent claims is possible.

According to claim 1, the object of the invention is achieved in that a motor vehicle lack is provided, having a locking mechanism with a catch and at least one pawl, wherein a rotational movement of the catch can be blocked by means of the pawl in at least one latching position, a drive device with which the pawl can be moved out of a blocking position into a release position for the rotary latch and a closing device, wherein the locking mechanism can be moved from a pre-ratchet position into a main ratchet position by means of the closing device, and wherein a coupling element can be controlled by means of the drive device in such a way that a setting up of the motor vehicle part can be made possible by means of the closing device. The structure of the motor vehicle latch according to the invention now makes it possible to use the motor vehicle latch or the components associated with the motor vehicle latch in such a way that, on the one hand, it is possible to close the locking mechanism and, at the same time, the motor vehicle part can be set up in an open position by means of the closing device. The design according to the invention allows the number of components required to move the locking mechanism and the motor vehicle part to be reduced to a minimum. Due to the use of the closing drive for pulling and mounting, comfort functions can be realized with a Minimum of structural components, which at the same time require only a minimal installation space.

In particular, the use of the drive device for actuating a coupling element can be advantageous, since the drive device can be assigned a dual function. The locking mechanism can be unlocked by means of the drive device. In other words, the locking mechanism can be moved out of a latching position into a release position. By means of the drive device, a release lever can be preferably actuated, with which the pawl can be moved out of engagement with the catch, so that the locking mechanism can be transferred from a latching position to a release position. After unlocking, the catch usually moves out of the engagement area with the pawl, at least in some areas, because the catch is under spring load from a leg spring and/or the door seal pressure.

The drive device is equipped with an electric drive, in particular an electric DC motor, so that the release lever can preferably be moved by means of a gearbox. According to the invention, the drive device additionally drives a coupling element, whereby the coupling element can be used to couple the closing device to a means for setting up the vehicle part. The electric drive of the drive unit is thus used in a dual function for unlocking the locking mechanism and operating the coupling element. This means that the existing components of the closing device and the drive device can also be used to set up the vehicle part.

According to the invention, when referring to a motor vehicle latch, synonyms such as locking device, lock or door lock are synonymous with each other. The term “motor vehicle latch” also includes locks that are used in doors, sliding doors, flaps and/or covers in motor vehicles, i.e. wherever components that can be pivoted or moved on the vehicle must be held securely in position. A preferred feature of the motor vehicle latch according to the invention relates to a side door latch. Motor vehicle locks of this type comprise a locking mechanism consisting of a rotary latch and a pawl.

The locking mechanism can also be equipped with two or more pawls or, for example, have a detent or blocking lever. Such pawls are known from the prior art. In this case, the pawl engages directly with the catch and the locking or blocking lever secures the position of the pawl in the latching position, preferably the main ratchet position.

According to a development of the invention, an advantage can be achieved if the closing device is accommodated in the motor vehicle at least in regions or completely independently of the motor vehicle latch. The closing device can be part of the motor vehicle latch itself, i.e. the closing device is integrated into the housing of the motor vehicle latch. For this purpose, the closing device preferably has a suitably powerful electric drive, by means of which the locking mechanism can be transferred from a pre-ratchet position to a main ratchet position. An appropriate design of the closing drive is necessary, since the locking mechanism must be moved against the sealing pressure of the door or flap. The main ratchet position represents the closed position of the locking mechanism and describes the position in which the movable component is held in the secured position on the motor vehicle latch. However, the closing drive can also be integrated only in regions into the lock or be mounted on the latch. A mechanical connection can then take place via levers, a linkage or via a Bowden cable. In any case, the closing device can initiate a closing movement into the locking mechanism. However, it is also possible in accordance with the invention for the closing device to be arranged at a distance from the locking device in the motor vehicle latch. This can be particularly advantageous if the motor vehicle latch is installed in a side door and sufficient installation space is not available in the vicinity of the motor vehicle latch for positioning the closing device. In this case, it is known to connect the pull drive to the motor vehicle latch or a drive device in the motor vehicle latch by means of a Bowden cable.

If the coupling device can be used to establish an operative connection between the raising device and the closing device, this results in a further embodiment of the invention. The coupling device is integrated into the motor vehicle latch and is actuated by means of the drive device. The coupling device is designed in such a way that the existing pull drive can be mechanically coupled to an raising device in the motor vehicle latch. In this case, the raising device can make use of existing components in the motor vehicle latch, at least in some areas, and enables the movable component to be moved into an open position. If the motor vehicle latch is unlocked by means of the drive unit, the catch is under pretension and is preferably moved out of the main latching position by the door seal pressure. Depending on the door seal pressure and design conditions, the movable component can move into the open position, at least in certain areas. The raising device, on the other hand, moves the movable component into a fixed open position, which is characterized by the fact that a gap is created into which the operator of the motor vehicle can safely reach in order to fully open the motor vehicle door, for example.

The opening position, which can be reached by achieving a fixed opening gap, is thus clearly different from the opening of the movable component by releasing the catch. In particular, for example, when an additional force is exerted on the movable component by, for example, a tilted position of the motor vehicle, which presses a side door into a closed position, for example. This can be gravity, for example, but can also be generated by external environmental influences, such as a strong wind. The opening position, on the other hand, is achieved by the raising device, whereby the movable component is moved into a defined position.

The closing device can be mechanically coupled to the raising device by means of the coupling element. The closing device is engaged in the mechanics of the raising device by means of the drive unit. For this purpose, the drive unit preferably has a gear downstream of the electric drive, which lifts the pawl off the catch either directly or via a separate release mechanism. After this unlocking of the locking mechanism, the electric drive of the drive unit can be used to couple the closing device to the raising device. The closing drive can then initiate a movement into the raising device, with a Bowden cable, for example, initiating a pulling movement into the motor vehicle latch, which is used to actuate the mechanism for setting up the movable component. For this purpose, for example, the gearbox of the drive device downstream of the electric motor can be used in that the gearbox, for example, moves the release mechanism to a position in which the release mechanism couples the closing drive to the raising device. After coupling the raising device, the mechanism for positioning the movable component is able to move the movable component into the opening position.

If the operator now grips and opens the movable component, the raising device can be moved back to its initial position, with the drive unit also being moved back to its initial positions and the closing drive being coupled again with the closing mechanism for the locking mechanism. This means that, on the one hand, electrical unlocking, closing and setting up can be realized with the simplest mechanical means and the smallest possible number of components.

A further embodiment of the invention results when the vehicle part arranged movably on the motor vehicle can be held by means of an erector of the raising device. The raising device has a steeper position, which can be moved out of a starting position into a Position in which the slider has moved the movable vehicle part into the open Position. In accordance with the invention, it is possible to imagine that the opener holds the vehicle part movably arranged on the motor vehicle, i.e. fixes it in the open position. Preferably, the opener is arranged in its initial position in the motor vehicle latch in such a way that the opener does not protrude beyond an outer body of the motor vehicle or a panel of the vehicle part. In this initial position, therefore, no obstruction of the operator of the motor vehicle can occur or injuries can be sustained. When the raising device moves the divider, the divider is moved from the starting position to the extended operating position. In this operating position, the divider is able to hold the vehicle part.

It can also be advantageous if the slider can be brought into engagement with a latch holder. In an advantageous manner, the divider can be arranged in the motor vehicle latch in such a way that the divider is arranged, for example, parallel to the locking mechanism and preferably parallel to the catch in the motor vehicle latch. The catch engages with the lock holder or lock holder bracket and secures the position of the pivoting component during operation of the motor vehicle. If the divider is now also brought into engagement with the lock holder, an advantageous design variant can be achieved. The advantage is that no further opening has to be provided in the motor vehicle latch, as the divider can be engaged with the lock holder through the inlet mouth of the catch. It is also advantageous in that the lock holder is arranged at a distance from, for example, the door seal in the motor vehicle, and therefore the smallest possible movement of the positioner is suitable for moving the movable motor vehicle part into the open position.

In a further variant of the invention, the closing mechanism is directly engageable with the catch. The closing mechanism or closing device can be engaged with the smallest possible number of structural components and thus directly with the catch. Decoupling the closing device plays a decisive role here, as the catch can be moved independently after decoupling from the closing device. In other words, the catch is released from the closing mechanism. This achieves easy movement of the locking mechanism and prevents noise. The closing device is only engaged by means of the coupling when the catch is in the release position, i.e. when the raising device is in engagement with the closing device. The decoupling of the closing device therefore offers structural and acoustic advantages. Likewise, the raising device is coupled by means of the closing device only in the case of installation or retraction of the raising device and is decoupled during closing. Coupling is performed mechanically and preferably by means of a gearbox connected downstream of the electric drive of the drive unit. Of course, it is also possible for a separate coupling element to be actuated, whereby the coupling element couples the Bowden cable to the closing drive or the raising device, for example.

The catch can be transferred from the release position into a latching position, in particular a main ratchet position, by means of the closing mechanism. If the closing mechanism, that is, the motor vehicle latch according to the invention, is installed in a side door of a motor vehicle, the closing mechanism moves the catch from a pre-ratchet position to a main ratchet position. However, there are also cases, for example with covers or tailgates, in which there is only a detent position in the locking mechanism. In these cases, the catch immediately engages with a lock holder as soon as the motor vehicle latch approaches the locking bolt. In this case, the closing device moves the catch from the contact position on the lock holder to the latching position.

It can also be advantageous if the coupling is designed as a mechanical coupling with a sliding element. The coupling device has, for example, a sliding element in which a mechanical connection of the closing drive can be guided linearly. A linear guide can be easily and safely produced and can be guided in the lock housing itself, for example. Therefore, the number of components required is reduced to a Minimum.

If the coupling device has a coupling for a Bowden cable receptacle of the closing device, this results in a further embodiment of the invention. The closing drive or closing device can interact with the closing system by means of a Bowden cable, enabling the closing device to be arranged at a distance from the vehicle in an advantageous manner. If the coupling device has a Bowden cable receptacle and the Bowden cable receptacle is accommodated in the coupling device so that it can be pivoted or moved, for example, it is possible to engage the closing mechanism or the setting mechanism advantageously. In particular, a connection of the coupling device to a gearbox of the drive device and, for example, a mechanical system associated with the drive device, such as a gearwheel, can be a structurally favorable way to enable coupling. The pivoting movement of the gearbox of the drive device can then be used to connect the Bowden cable of the closing device to the raising device or the catch or the closing mechanism.

The object of the invention can be solved by means of a method. For this purpose, according to the invention, a method is provided for closing a motor vehicle part of a motor vehicle which can be closed by means of a motor vehicle latch, in which a latch of the motor vehicle latch is unlocked by means of a drive device and the vehicle part is transferred into a latching position by means of a closing device, and in which the closing device is then coupled to a raising device by means of the drive device. The method according to the invention now makes it possible to use the closing drive arranged in the motor vehicle latch or on the motor vehicle latch also for setting up the component movably attached to the motor vehicle. The method according to the invention makes use of the possibility of coupling the closing drive with the installation device by means of a coupling element and therefore performing the two functions by means of one drive. After unlocking the locking mechanism, the drive device interacts with the coupling in such a way that the closing drive is coupled to the installation mechanism or raising device, thus enabling the movable vehicle part to be installed. After the raising device has been set up and retracted, it is again decoupled from the closing device by means of the drive unit and connected to the closing mechanism or directly to the catch. In turn, pulling of the catch is possible.

The invention is explained in more detail below with reference to the accompanying drawings and sketches. However, the principle applies that the embodiment does not limit the invention, but is merely an advantageous embodiment. The features shown can be implemented individually or in combination with further features of the description as well as the claims—individually or in combination.

In the drawings:

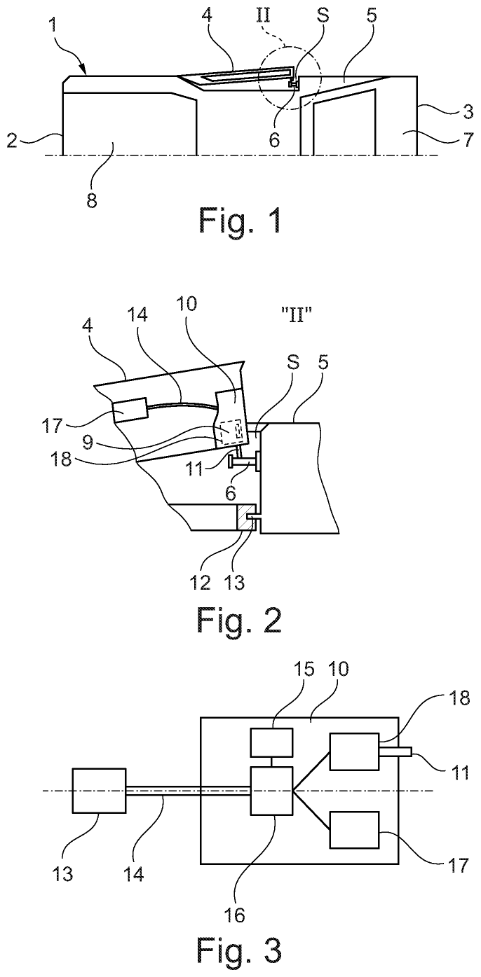

FIG. 1 shows a top view of a motor vehicle with a side door in an open position;

FIG. 2 a detailed view of the side door in the open position as shown in FIG. 1, and in particular view II, in a sectional view showing the principle arrangement between a motor vehicle latch located in the side door and an raising device, the raising device cooperating with a lock holder; and

FIG. 3 shows a basic sketch of the interaction between the closing drive, the drive unit, the coupling element, the closing mechanism and the set-up mechanism.

FIG. 1 shows a top view of a motor vehicle 1 shown in principle. The motor vehicle 1 has a front area 2, a rear area 3 and a side door 4. The motor vehicle side door 4 is shown in an open position, the open position being characterized by the fact that there is an opening gap S between the motor vehicle body 5 and the side door 4. In the area of the opening gap S, a lock holder 6 can be seen, which in this exemplary embodiment is designed as a locking bolt 6. Even though in this exemplary embodiment the raising device is reproduced using the example of a motor vehicle door 4, this is not limiting. It is also possible to use the raising device, for example, for a tailgate 7 located in the rear of the motor vehicle 3 or, for example, for an engine hood 8 located in the area of the front of the motor vehicle.

FIG. 2 shows an enlarged view of detail II from FIG. 1 in the area of the lock holder 6. Identical components are given the same reference numbers in the figures. For better clarification of the arrangement of the raising device 9, detailed view II is reproduced in a section through the motor vehicle 1 above the latch holder 6. The raising device 9 is integrated into a motor vehicle door latch 10 and has an upright 11, the upright 11 cooperating directly with the latch holder 6. In this embodiment, the divider 11 is integrated and movably arranged in the raising device 9 in such a way that the divider 11 can be moved out of the motor vehicle door latch 10 and the motor vehicle door (4). A door seal 12 is attached to a bend 13 of the motor vehicle body 5. The door seal 12 preferably circumferentially surrounds the motor vehicle door 4 and seals the interior of the motor vehicle 1 from the environment. In addition to this sealing function, the door seal 12 generates a force on the door lock integrated in the motor vehicle door 4 and in particular the locking mechanism, insofar as the motor vehicle door 4 is in the fully closed locking position.

This door seal pressure can be used by the motor vehicle door latch 10 to open the latch by merely removing the pawl from the catch and allowing the door seal force or door seal pressure to cause the catch to move, that is, to open the locking mechanism. Subsequently, the raising device 9 then moves the motor vehicle door 4 completely to the open position, resulting in the opening gap S.

FIG. 3 now shows in principle the arrangement of the motor vehicle door latch 10 in relation to a closing device 13. The closing device 13 is arranged here at a distance from the motor vehicle latch 10, and is connected to the motor vehicle latch 10, for example by means of a Bowden cable 14. A drive device 15, a coupling element 16, a closing mechanism 17 and an installation mechanism 18 are integrated in the motor vehicle latch 10. A divider 11 is movable out of the motor vehicle latch 10 and into the motor vehicle latch 10.

If the motor vehicle latch 10 or the motor vehicle door 4 is now in the position shown in FIG. 2, the closing device 13 is connected to the opening mechanism 18 via the coupling element 16. The divider 11 is in the extended position. If the motor vehicle door 4 is now gripped by the operator and opened completely, the closing device 13 moves the spring 11 back into the retracted position into the initial position. The drive unit then actuates the coupling element and couples the closing device 13 to the closing mechanism 17. If the operator now moves the motor vehicle door back to the closed position, with the catch moving to a pre-ratchet position, the closing device 13 and the associated closing mechanism 17 can be used to transfer the locking mechanism from a pre-ratchet position to a main ratchet position. The closing device 13 can therefore be used as required to pull or set up the motor vehicle door. In other words, the force flow of the actuator or the closing device 13 can be coupled via the coupling element 16 to the respective functional components 17 and 18. This is why, no additional actuator is necessary, since the drive device 15, which usually initializes an electrical opening, is used for coupling the closing or installation mechanism 17 and 18.

According to the invention, the closing device 13 can therefore be used to set up the side door 4 and to pull the locking mechanism. Both comfort functions are therefore carried out by existing components, so that comfort functions can be provided with a minimum of design resources, with little installation space and thus at low cost.

### LIST OF REFERENCE SIGNS

1 motor vehicle
2 Front area
3 Rear area
4 Motor vehicle door
5 Vehicle body
6 Lock holder
7 Tailgate
8 Engine hood
9 Raising device
10 Motor vehicle latch
11 Divider
12 Door seal
13 Closing device
14 Bowden cable
15 Drive device
16 Clutch element
17 Closing mechanism
18 Installation mechanism
S Opening gap

1. A motor vehicle lock for a motor vehicle, the motor vehicle lock comprising:
a locking mechanism with a catch and at least one pawl, wherein a rotary movement of the catch is locked in at least one locking position by the pawl,
a drive mechanism that drives the pawl to transfer the pawl from a blocking position with the catch in the at least one locking position into a release position for the catch,
a closing device, wherein the at least one locking position include a pre-ratchet position and a main ratchet position, and the locking mechanism is transferred from the pre-ratchet position into the main ratchet position by the closing device, and
a coupling element that is controlled by the drive mechanism in such a way that a position of a vehicle part different from the locking mechanism is set by the closing device.

2. The motor vehicle lock according to claim 1, wherein the closing device is received in the motor vehicle at least in regions independent of the motor vehicle lock.

3. The motor vehicle lock according to claim 1, wherein the coupling element provides an operative connection between a raising device for the vehicle part and the closing device.

4. The motor vehicle lock according to claim 3, wherein the closing device is mechanically coupled to the raising device by the coupling element.

5. The motor vehicle lock according to claim 3, wherein the vehicle part is holdable by an erector of the raising device.

6. The motor vehicle lock according to claim 5, wherein the raising device includes a divider that is engageable with a lock holder for holding the catch.

7. The motor vehicle lock according to claim 1, wherein the catch is transferred from the release position into the main latching position by the closing device.

8. The motor vehicle lock according to claim 1, wherein the closing device is directly engageable with the catch.

9. The motor vehicle lock according to claim 1, wherein the coupling element comprises a mechanical coupling with a sliding element.

10. The motor vehicle lock according to claim 1, wherein the coupling element has a coupling for a Bowden cable receptacle of the closing device.

11. A method for closing a vehicle part of a motor vehicle which can be closed by means of a motor vehicle latch, in which a locking mechanism of a motor vehicle latch is unlocked by means of a drive device, and the vehicle part is transferred into a latching position by means of a closing device, and in which the closing device is then coupled to a setting-up mechanism by means of the drive device.

12. The motor vehicle lock according to claim 1, wherein the closing device includes an electric drive to transfer the locking mechanism from the pre-ratchet position into the main ratchet position.

13. The motor vehicle lock according to claim 1, wherein the drive mechanism includes a gear that moves the pawl from the blocking position.

14. The motor vehicle lock according to claim 6, wherein the divider is arranged parallel to the catch.

15. The motor vehicle lock according to claim 1, wherein the closing device is connected to the locking mechanism by a Bowden cable.
